(19) United States
(12) Patent Application Publication
(10) Pub. No.: US 2014/0188628 A1
(43) Pub. Date: Jul. 3, 2014

(54) DISTRIBUTION OF PAYMENTS RELATING TO OFFER ADVERTISEMENTS

(71) Applicant: BANK OF AMERICA CORPORATION, Charlotte, NC (US)

(72) Inventor: David M. GRIGG, Rock Hill, SC (US)

(73) Assignee: BANK OF AMERICA CORPORATION, Charlotte, NC (US)

(21) Appl. No.: 13/732,382

(22) Filed: Jan. 1, 2013

(51) Int. Cl. G06Q 30/02

(52) U.S. Cl. CPC G06Q 30/0273
USPC 705/14.69

(57) ABSTRACT

Embodiments for distributing payments for offer advertisements and settling offers are provided herein. The embodiments include receiving payment data from a merchant, the payment data comprising at least one payment for advertising; identifying one or more advertising providers based on the payment data; determining the amount owed to each of the one or more advertising providers; and distributing at least a portion of the at least one payment to at least one of the one or more advertising providers based on the determined amount.

### BACKGROUND

Businesses often provide and receive many different types of services and goods. In day-to-day operations, a business may send out bills to many different suppliers to receive payments, and the business may also send payments to a large number of different recipients. Tracking payments and progress related to a wide variety of services and goods is often a time consuming and complex process.

### BRIEF SUMMARY

The embodiments provided herein are directed to a system for distributing payments for offer advertisements. In some embodiments, the system includes a computer apparatus including a processor and a memory; and a distribution software module stored in the memory, comprising executable instructions that when executed by the processor cause the processor to receive payment data from a merchant, the payment data comprising at least one payment for advertising. In some embodiments, the module is further configured to identify one or more advertising providers based on the payment data. In other embodiments, the module is further configured to determine the amount owed to each of the one or more advertising providers. In still other embodiments, the module is further configured to distribute at least a portion of the at least one payment to at least one of the one or more advertising providers based on the determined amount.

In further embodiments, the payment data further comprises merchant identifiers, advertising provider identifiers, financial account information, customer account information, balances, advertising data, and offer data. In some embodiments, the module is further configured to: compare the advertising currently provided to the merchant with previous advertising; determine a change in advertising; and increase or decrease the amount owed in accordance with the change in advertising. In other embodiments, the module is further configured to: calculate the difference of the amount owed and the at least one payment; determine that the amount owed is less than the at least one payment; and return the difference to the merchant. In still other embodiments, the module if further configured to: calculate the difference of the amount owed and the at least one payment; determine that the amount owed is greater than the at least one payment; and request the difference from the merchant.

In other embodiments of the system, the module is further configured to: receive advertising data from the advertising provider, wherein the advertising data is associated with the merchant or as set of other merchants. In still other embodiments, the module is further configured to: categorize the advertising data according to a type of advertising channel, a type of product, or a type of offer; determine the amount of business activity in each category; and provide a recommendation to the merchant based on the determination. In additional embodiments, the module is further configured to: analyze the advertising data; and determine one or more trends based on the analysis. In some embodiment, the set of other merchants include merchants that have a type of business that is similar to the merchant's type of business. In further embodiments, the set of other merchants include merchants that have a type of business that is different from the merchant's type of business. In still further embodiments, the payment data further comprises at least one payment for settling offers.

Embodiments directed to a computer program product for distributing payments for offer advertisements are also provided herein. In some embodiments, the computer program product includes a computer readable storage medium having computer readable program code embodied therewith, the computer readable program code comprising: computer readable program code configured to receive payment data from a merchant, the payment data comprising at least one payment for advertising. In other embodiments, the computer program product includes computer readable program code configured to identify one or more advertising providers based on the payment data. In still other embodiments, the computer program product includes computer readable program code configured to determine the amount owed to each of the one or more advertising providers. In further embodiments, the computer program product includes computer readable program code configured to distribute at least a portion of the at least one payment to at least one of the one or more advertising providers based on the determined amount.

In some embodiments of the computer program product, the payment data further comprises merchant identifiers, advertising provider identifiers, financial account information, customer account information, balances, advertising data, and offer data. In other embodiments, the computer program product includes computer readable program code configured to compare the advertising currently provided to the merchant with previous advertising; determine a change in advertising; and increase or decrease the amount owed in accordance with the change in advertising. In still other embodiments, the computer program product includes computer readable program code configured to receive advertising data from the advertising provider, wherein the advertising data is associated with the merchant; categorize the advertising data according to a type of advertising channel, a type of product, or a type of offer; determine the amount of business activity in each category; and provide a recommendation to the merchant based on the determination. In additional embodiments, the computer program product includes computer readable program code configured to receive advertising data from the advertising provider, wherein the advertising data is associated with a set of other merchants; analyze the advertising data; and determine one or more trends based on the analysis.

Embodiments directed to a method for distributing payments for offer advertisements is further provided herein. In some embodiments, the method includes receiving, at a computing device, payment data from a merchant, the payment data comprising at least one payment for advertising. In some embodiments, the method includes identifying, as performed by a computing device processor, one or more advertising providers based on the payment data. In some embodiments, the method includes determining, as performed by a computing device processor, the amount owed to each of the one or more advertising providers. In some embodiments, the method includes distributing, as performed by a computing device processor, at least a portion of the at least one payment to at least one of the one or more advertising providers based on the determined amount.

In some embodiment of the method, the method includes comparing, as performed by a computing device processor, the advertising currently provided to the merchant with previous advertising; determining, as performed by a computing device processor, a change in advertising; and increasing or decreasing, as performed by a computing device processor, the amount owed in accordance with the change in advertising. In other embodiments, the method includes receiving, as performed by a computing device processor, advertising data from the advertising provider, wherein the advertising data is associated with the merchant; categorizing, as performed by a computing device processor, the advertising data according to a type of advertising channel, a type of product, or a type of offer; determining, as performed by a computing device processor, the amount of business activity in each category; and provide a recommendation to the merchant based on the determination. In some embodiments, the method includes receiving, as performed by a computing device processor, advertising data from the advertising provider, wherein the advertising data is associated with a set of other merchants; analyzing, as performed by a computing device processor, the advertising data; and determining, as performed by a computing device processor, one or more trends based on the analysis.

### BRIEF DESCRIPTION OF THE SEVERAL VIEWS OF THE DRAWINGS

The present embodiments are further described in the detailed description which follows in reference to the noted plurality of drawings by way of non-limiting examples of the present embodiments in which like reference numerals represent similar parts throughout the several views of the drawings and wherein:

FIG. 1A provides a block diagram illustrating a system and environment for distributing data related to offers and/or advertisements in accordance with various embodiments;

FIG. 1B provides a block diagram illustrating a system and environment for distributing data related to offers and/or advertisements in accordance with various embodiments;

FIG. 1C provides a block diagram illustrating a system and environment for distributing data related to offers and/or advertisements in accordance with various embodiments;

FIG. 1D provides a block diagram illustrating a system and environment for distributing data related to offers and/or advertisements in accordance with various embodiments;

FIG. 2 provides a block diagram illustrating the distribution system, the first merchant system, and the first advertising provider system of FIGS. 1A-1D, in accordance with various embodiments;

FIG. 3 is a flowchart illustrating a system and method for distributing payments relating to offer advertisements in accordance with various embodiments; and

FIG. 4 is a flowchart illustrating a system and method for distributing payments relating to offer advertisements in accordance with various embodiments.

### DETAILED DESCRIPTION

The embodiments presented herein are directed to systems and methods for distributing payments related to offer advertisement and offer settlements. In some embodiments, a distribution system receives a payment from at least one merchant and distributes at least a portion of the payment to one or more advertising providers. The system, in some embodiments further tracks and gathers information relating to the advertising. In this way, the process for sending and receiving payments and monitoring progress is streamlined for all participating parties.

The embodiments of the disclosure may be embodied as a system, method, or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present embodiments of the disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present embodiments of the disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present embodiments of the disclosure are described below with reference to flowchart illustrations and/or block diagrams of methods, apparatus (systems) and computer program products according to embodiments of the embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As presented herein, embodiments that distribute payments relating to offer advertisement and analyze advertisement related data are provided. As used herein, the term “offer” refers to, but is not limited to, rewards, discounts, incentives, and other options. Exemplary offers include cash back offers, gift cards, coupons, free trials, free memberships, free services, free upgrades, discounted goods or services, lower interest rates, higher discount rates, more frequent rewards, and the like.

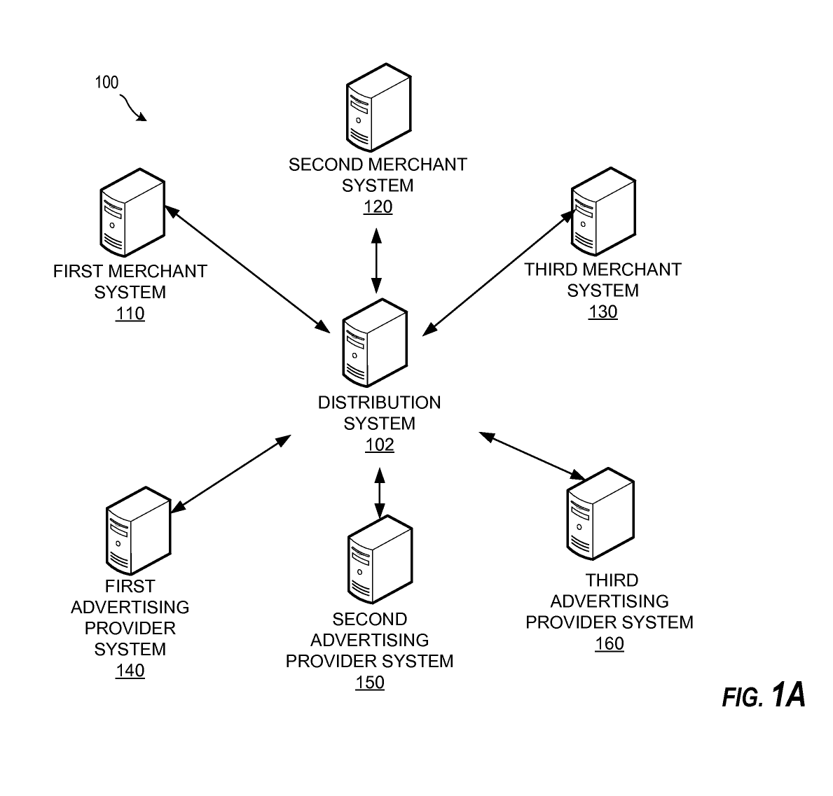

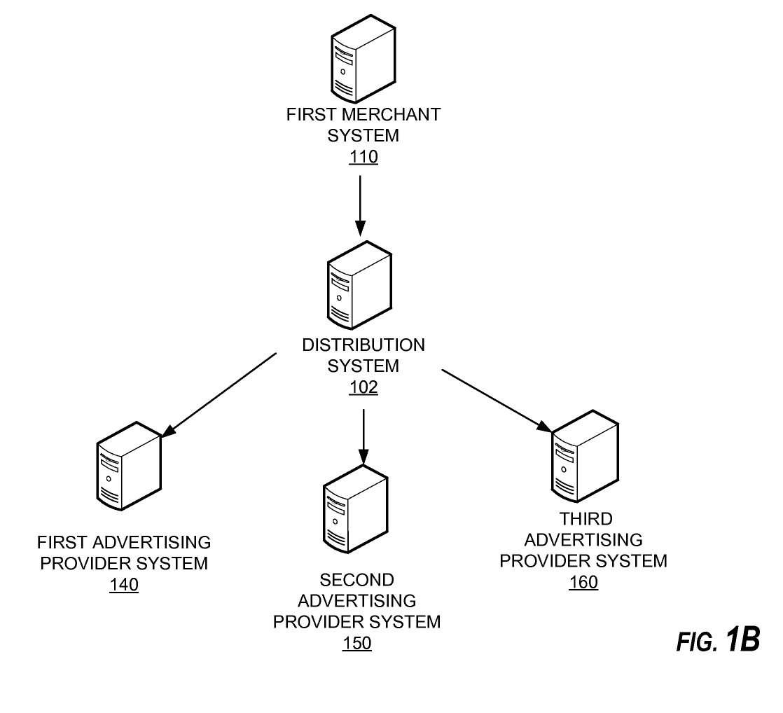

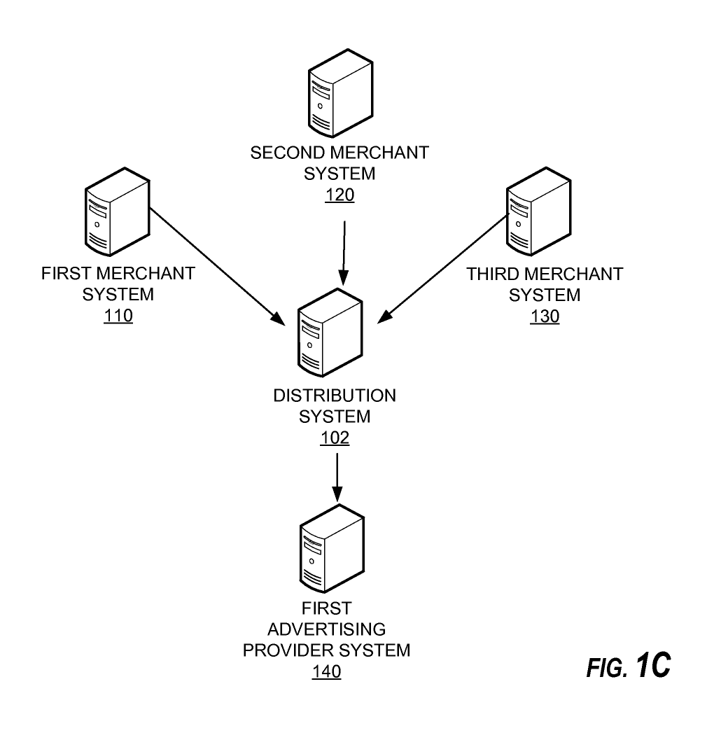

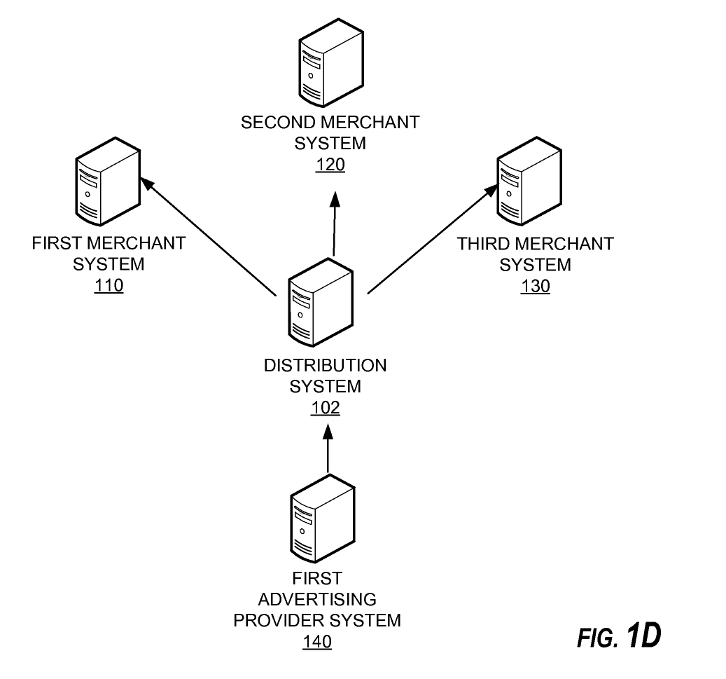

Referring now to the figures, FIGS. 1A-1D provide block diagrams illustrating a system and environment 100 for distributing data relating to offers and/or advertisements is provided. For example, the system and environment 100 may distribute payments, analytics, advertisement requests, advertisement bids, or any other data associated with offers, advertising, or advertising channels.

As shown in FIG. 1A, a distribution system 102 for distributing data to merchant systems 110, 120, 130 and/or advertising provider systems 140, 150, and 160 is provided. In some embodiments, the distribution system 102 is operably connected to the first merchant system 110, the second merchant system 120, the third merchant system 130, the first advertising provider system 140, the second advertising provider system 150, and/or the third advertising provider system 160. The distribution system 102 sends data to and/or receives data from the merchant systems 110, 120, 130 and the advertising provider systems 140, 150, 160. Although FIGS. 1A-1D illustrate a certain number of merchant systems and advertising provider systems, it will be understood that the system and environment 100 may include any number of such systems.

As illustrated in FIG. 1B, the first merchant system 110 sends data to the distribution system 102. For example, the distribution system 102 may receive one or more payments, one or more advertising requests, one or more advertising bids, or other data from the first merchant system 110. The distribution system 102, in some embodiments, processes and/or analyzes the data and distributes at least a portion of the data received from the first merchant system 102 to at least one of the advertising provider systems 140, 150, 160. For example, the distribution system 102 may receive a single payment from the first merchant system 110 and distribute certain portions of the payment to the advertising provider systems 140, 150, 160. In another example, the distribution system 102 may distribute one or more advertising bids received from the first merchant system 110 to the advertising providers 140, 150, 160. In this way, the distribution process is streamlined such that the merchant system 110 can send data to one source instead of sending the data to multiple sources. In the illustrated embodiment, rather than the merchant system 110 determining targeted recipients and distributing data, the distribution system 102 identifies data recipients and provides the identified recipients with the correct data.

As illustrated in FIG. 1C, the distribution system 102 also receives data from multiple merchants (i.e., the merchant systems 110, 120, 130) and distributes the data to the first advertising provider system 140. For example, the first advertising provider system 140 may receive monthly payments from many merchants at various times and for many different services and goods. The distribution system 102 can use the payment information to determine how much of the payment the first advertising provider system 140 is to receive, and distributes the multiple payments accordingly. Moreover, in cases where the first advertising provider system 140 needs to send data to a number of different recipients such as the merchant systems 110, 120, 130, the first advertising provider system 140 can send the data to the distribution system 102, which can distribute the data (see, FIG. 1D). In the illustrated embodiment of FIG. 1D, the merchant systems 110, 120, 130 receives data such as confirmations, contract data, counter offers, statements, refunds, payments, and other types of data from the first advertising provider system 140 via the distribution system 102.

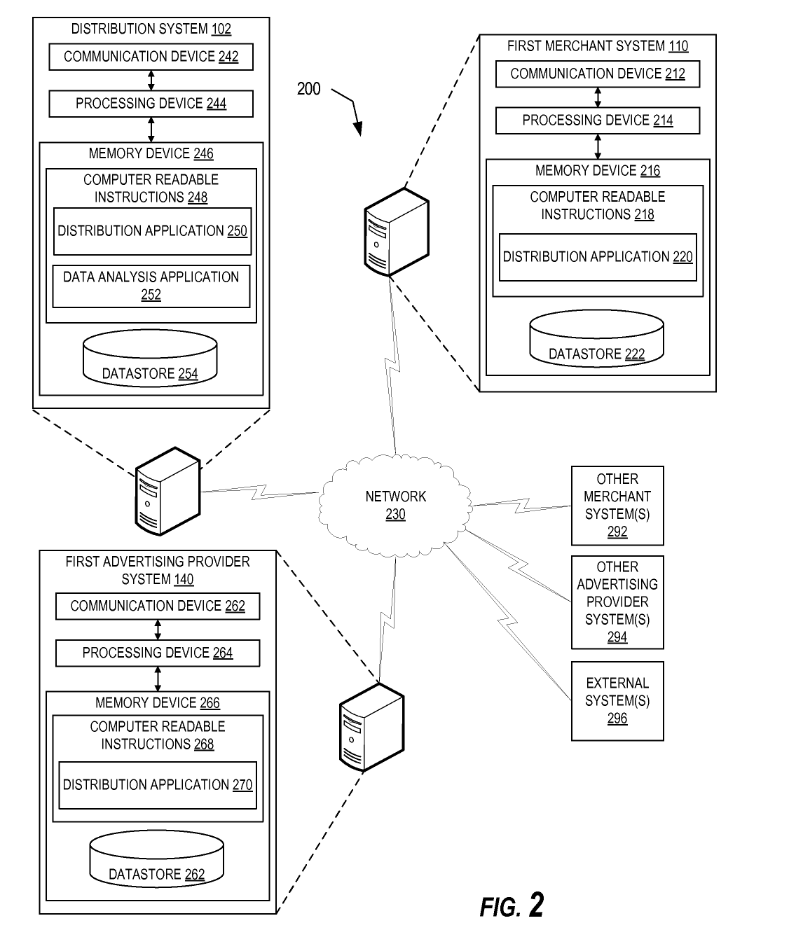

Referring now to FIG. 2, a block diagram illustrates an environment 200 for distributing data relating to offer advertisements. The environment 200 includes the distribution system 102, the first advertising provider 140, and the first merchant system 110 of FIGS. 1A-1D. The environment 200 further includes one or more other merchant systems 292 (e.g. the second and third merchant systems 120, 130), one or more other advertising provider systems 294 (e.g., the second and third advertising provider systems 150, 160), and one or more external systems 296. The systems and devices communicate with one another over a network 230 and perform one or more of the various steps and/or methods according to embodiments of the disclosure discussed herein. The network 230 may include a local area network (LAN), a wide area network (WAN), and/or a global area network (GAN). The network 230 may provide for wireline, wireless, or a combination of wireline and wireless communication between devices in the network. In one embodiment, the network 230 includes the Internet.

The distribution system 102, the first merchant system 110, and the first advertising provider system 140 each includes a computer system, server, multiple computer systems and/or servers or the like. The distribution system 102, in the embodiments shown has a communication device 242 communicably coupled with a processing device 244, which is also communicably coupled with a memory device 246. The processing device 244 is configured to control the communication device 242 such that the distribution system 102 communicates across the network 230 with one or more other systems. The processing device 244 is also configured to access the memory device 246 in order to read the computer readable instructions 248, which in some embodiments includes a distribution application 250. The memory device 246 also includes a datastore 254 or database for storing pieces of data that can be accessed by the processing device 244.

As used herein, a “processing device,” generally refers to a device or combination of devices having circuitry used for implementing the communication and/or logic functions of a particular system. For example, a processing device may include a digital signal processor device, a microprocessor device, and various analog-to-digital converters, digital-to-analog converters, and other support circuits and/or combinations of the foregoing. Control and signal processing functions of the system are allocated between these processing devices according to their respective capabilities. The processing device 214, 244, or 264 may further include functionality to operate one or more software programs based on computer-executable program code thereof, which may be stored in a memory. As the phrase is used herein, a processing device 214, 244, or 264 may be “configured to” perform a certain function in a variety of ways, including, for example, by having one or more general-purpose circuits perform the function by executing particular computer-executable program code embodied in computer-readable medium, and/or by having one or more application-specific circuits perform the function.

As used herein, a “memory device” generally refers to a device or combination of devices that store one or more forms of computer-readable media and/or computer-executable program code/instructions. Computer-readable media is defined in greater detail below. For example, in one embodiment, the memory device 246 includes any computer memory that provides an actual or virtual space to temporarily or permanently store data and/or commands provided to the processing device 244 when it carries out its functions described herein.

The first merchant system 110 includes a communication device 212 communicably coupled with a processing device 214, which is also communicably coupled with a memory device 216. The processing device 214 is configured to control the communication device 212 such that the first merchant system 110 communicates across the network 230 with one or more other systems. The processing device 214 is also configured to access the memory device 216 in order to read the computer readable instructions 218, which in some embodiments includes a distribution application 220. The memory device 216 also includes a datastore 222 or database for storing pieces of data that can be accessed by the processing device 214.

The first advertising provider system 140 includes a communication device 262 communicably coupled with a processing device 264, which is also communicably coupled with a memory device 266. The processing device 264 is configured to control the communication device 262 such that the first advertising provider system 140 communicates across the network 230 with one or more other systems. The processing device 264 is also configured to access the memory device 266 in order to read the computer readable instructions 268, which in some embodiments includes a distribution application 270. The memory device 266 also includes a datastore 262 or database for storing pieces of data that can be accessed by the processing device 264.

In some embodiments, the advertising provider distribution provider application 270 and the merchant distribution application 220 interacts with the distribution server distribution application 250 to access information, documents, payments, bids, requests, or other data for use in analyzing and distributing such data. In some embodiments, a data analysis application 252 stored in the memory device 246 of the distribution system 102 retrieves information regarding offers and/or advertising in determining trends, producing graphs, providing recommendations, and the like.

The applications 220, 250 and 270 are for instructing the processing devices 214, 244 and 264 to perform various steps of the methods discussed herein, and/or other steps and/or similar steps. In various embodiments, one or more of the applications 220, 250 and 270 are included in the computer readable instructions stored in a memory device of one or more systems other than the systems 102, 110, and 140. For example, in some embodiments, the application 220 is stored and configured for being accessed by a processing device of one or more other merchant systems 292 connected to the network 230. In various embodiments, the applications 220, 250 and 760 stored and executed by different systems/devices are different. In some embodiments, the applications 220, 250 and 270 stored and executed by different systems may be similar and may be configured to communicate with one another, and in some embodiments, the applications 220, 250 and 270 may be considered to be working together as a singular application despite being stored and executed on different systems.

In various embodiments, one of the systems discussed above, such as the distribution system 102, is more than one system and the various components of the system are not collocated, and in various embodiments, there are multiple components performing the functions indicated herein as a single device. For example, in one embodiment, multiple processing devices perform the functions of the processing device 244 of the distribution system 102 described herein. In various embodiments, the distribution system 102 includes one or more of the external systems 296 and/or any other system or component used in conjunction with or to perform any of the method steps discussed herein. For example, the distribution system 102 may include a financial institution system, a credit agency system, and the like.

In various embodiments, the distribution system 102, the first merchant system 110, and the first advertising provider system 140 and/or other systems may perform all or part of a one or more method steps discussed above and/or other method steps in association with the method steps discussed above. Furthermore, some or all the systems/devices discussed here, in association with other systems or without association with other systems, in association with steps being performed manually or without steps being performed manually, may perform one or more of the steps of method 100, the other methods discussed below, or other methods, processes or steps discussed herein or not discussed herein.

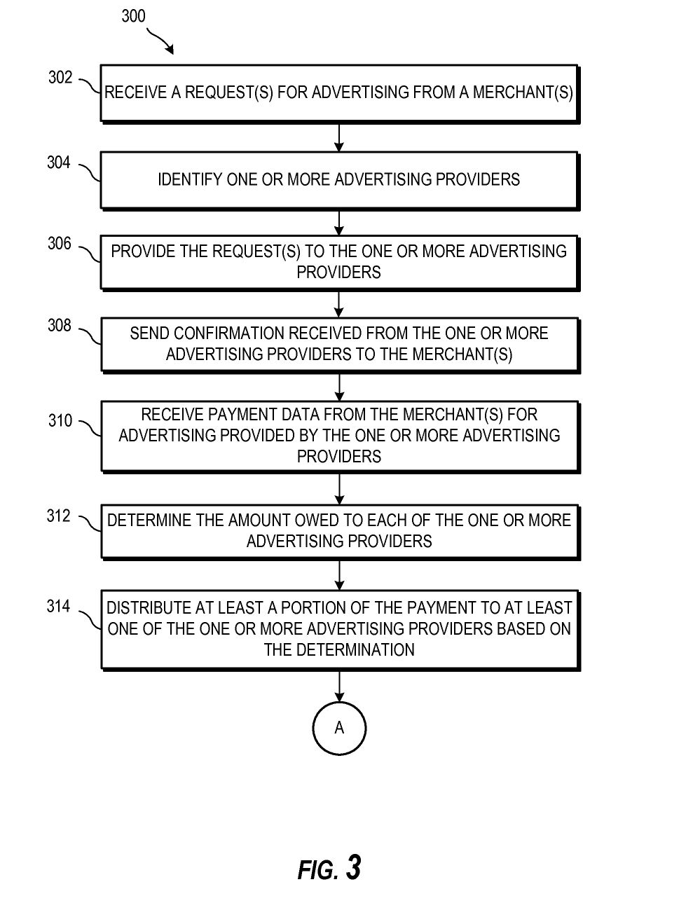

FIG. 3 illustrates a flowchart providing an overview of a process 300 for distributing payments relating to offer advertisements. In other embodiments, the process 300 also analyzes data associated with the offer advertisements. In still other embodiments, the process 300 further distributes payments for settling offers. One or more devices, such as the one or more mobile devices and/or one or more other computing devices and/or servers of FIGS. 1A-1D and FIG. 2, can be configured to perform one or more steps of the process 300. In some embodiments, the one or more devices performing the steps are associated with a financial institution. In other embodiments, the one or more devices performing the steps are associated with a business, partner, third party, social network, offer provider, credit agency, and/or user.

As illustrated at block 302, one or more requests for advertising is received from one or more merchants. In general, the request includes information relating to offer advertisements. The request includes, in some embodiments, information related to an offer, a type of advertising channel, an advertising provider, cost information, advertising periods, and/or the like. The one or more merchants include online retailers, brick and mortar retailers, manufacturers, product providers, whole sale providers, third parties associated with the one or more merchants, offer providers, financial institutions, and the like. In some embodiments, the one or more requests comprise a bid for offer advertisements. For example, the request may include the type of advertising channel the one or more merchant desire for an advertising campaign that includes specific offers and a specific targeted audience.

As illustrated at block 304, one or more advertising providers are identified. The advertising providers include systems, servers, or any businesses that provide advertising channels or advertising services. Exemplary advertising providers include social media providers, internet providers, web page providers, mobile application providers, television networks, cable television or satellite television providers, radio service providers, printed publication providers, organizations that permit advertising, advertising agencies, partners of the advertising providers, and the like.

In some embodiments, the one or more advertising channel providers are identified based on the one or more requests. For example, the one or more request may include a type of advertising channel such as pop-up advertisements, social media feed, click advertisements, television advertisements, radio advertisements, mobile application advertisements, advertisements related to a specific media outlet, and the like. Advertising providers that are capable of providing the specified type of advertising channel can be identified based on the request.

In still other examples, advertising providers can be identified based on any number of criteria included or not included in the request. In some examples, advertising providers that have customers in a specific demographic range can be identified based on the one or more requests. In other examples, criteria for identifying the one or more advertising providers include whether the advertising provider is a local business, national business, or international business. The one or more merchants may only want to work with locally owned advertising providers, for example, to target local audiences. If a wider audience is desired, the one or more merchants can choose an advertising provider with a wider audience or capabilities.

The one or more advertising providers can also be identified based on the number of advertising channels it provides. For example, an advertising provider that has online, paper, social media, mobile application, and other advertising capabilities may be better suited to a merchant seeking an advertising blitz for a new product. In other cases, an advertising provider that specialized in a specific type of advertising channel may be identified for a merchant that requests a targeted audience. Further or alternatively, the one or more advertising providers can be identified based on the goodwill, brand image, or popularity of the advertising provider.

In additional or alternative embodiments, the identification of the one or more advertising providers is based on the one or more merchants' past experience with the one or more advertising providers. For example, advertising providers may be identified based on whether such providers have provided advertising services to the one or more advertising providers during a previous period of time. If a merchant has used an advertising provider in the last six months for example, then the merchant may seek another advertising provider.

In additional examples, advertising providers with past relationships with the one or more merchants may be identified based on measured performance. Exemplary measured performance includes a rating, formula, ratio, index, factor, or other indicator. The measured performance may indicate, in some examples, increases or decreases in sales, advertising audience, new customers, and/or the like.

In other embodiments, the one or more advertising providers are identified based on data relating to the offer advertisements. For example, the advertising providers may be based on data related to a payment.

As illustrated at block 306, the one or more requests are provided to the one or more advertising providers. In one example, multiple requests may be received from a single merchant and at least one of the multiple requests may then be forwarded to the one or more advertising providers. In some embodiments, at least a portion of each of the one or more requests is provided to the one or more advertising providers. For example, the one or more merchants may include preferences that direct the system of process 300 to provide specific portions of the request to the one or more providers. The one or more advertising providers may be provided only with data necessary for fulfilling the request such as the wording of the offer advertisement, the terms of the offer, targeted audience, and when the offer advertisement should be presented, and not irrelevant or private information. The portion of the request to be provided to the one or more advertising providers can also be based on the preferences of the one or more advertising providers. For example, the entire request or only a portion of the request may be supplemented with additional data, reduced in size or content, and/or reformatted. The request can undergo various stages of adjustment before it is provided to the one or more advertising providers.

As illustrated at block 308, a confirmation received from the one or more advertising providers is sent to the one or more merchants. In some embodiments, the confirmation includes affirmation of receipt of the request. In other embodiments, the confirmation includes a change to the terms of the one or more requests, affirmation or rejection of the terms of the one or more requests, counter offers, a contract, and the like. For example, if an advertising provider chooses to amend the terms of the request, those amendments may be provided in the confirmation.

As illustrated at block 310, payment data from the one or more merchants for advertising provided by the one or more advertising providers is received. In some embodiments, the payment data includes at least one payment. The payment, in some embodiments, include payments for future, previous, and/or current advertising services or associated goods or services such as equipment or technical support. The payment, in other embodiments, includes payments for settling offers. The payment includes, for example, merchant identifiers, advertising provider identifiers, financial account information, customer account information, balances, advertising data, offer data, and the like. In some embodiments, the payment comprises one or more forms of payment. For example, the payment may include a check, a checking account number, a credit card, and the like. The payment can be a lump sum to be distributed to many different advertising providers, multiple payments to be distributed to one or more advertising providers, or the payment may be a sum for a single advertising provider. In some embodiments, the payment is received at a specific period of time or frequency. For example, the payment may be received once a month or twice a year.

In some embodiments, the one or more advertising providers are identified based on the payment. For example, the payment information may include account numbers or identifiers associated with a particular advertising provider. The payment can include a numerical code, alphanumerical code, algorithm, or some other indicator that identifies the provider that is to receive at least a portion of the payment. In other examples, the one or more advertising providers may be identified based on the description of the advertising service such as a type of advertising channel, an offer used in the advertising, a product associated with the offer, targeted audience, and the like.

As illustrated at block 312, the amount owed to each of the one or more advertising providers is determined. In some exemplary embodiments, the amount owed is based on the amount of the payment. For example, if the amount is within a predetermined range or an exact amount, then the amount may be matched to outstanding balances on statements provided by the one or more advertising providers. In other embodiments, the amount owed is based on the financial account associated with the payment, the type of payment, the frequency of the payment, and/or the time period the payment is received. For example, the payment may include a first amount associated with one checking account and a second amount associated with a second checking account. Based on the checking account numbers, the first amount may be matched to a first advertising provider and the second amount may be matched to a second advertising provider. In other examples, automatic payments or other types of payment may be assigned to a particular advertising provider. In still other examples, an advertising provider may be matched to payments received on particular day of the week, date, week, month, or if the payment is received a certain number of times within a week or month.

In some embodiments, historical data is used to determine the amount owed to each of the one or more advertising providers. For example, advertising provided to the merchant by the one or more advertising providers during a previous period of time is compared to the advertising that is currently being provided to the merchant. Based on this comparison, any changes to the advertising can be determined. If changes are identified, the amount owed to the one or more advertising providers can be increased or decreased accordingly.

In further embodiments, the difference of the amount owed and the payment is calculated. The amount owed, in some embodiments, is greater than, less than, or equal to the payment. In situations where there is an increase in the amount owed, the merchant can be requested to send the additional amount owed or the additional amount can be added to future balances. In situations where there is a decrease in the amount owed, a refund of the difference can be sent to the merchant, the difference can be applied to future balances, or the difference can be applied to other amounts owed to other advertising providers.

In additional embodiments, the amount owed to each of the one or more advertising providers is determined based on specific features of the advertising. For example, the pricing scheme for a particular merchant may be based on the level of the advertising, the one or more merchant's total amount of business with the one or more advertising providers, the relationship of the one or merchants with the one or more advertising providers, the length of that relationship, and the like. In one example, the cost of advertising may be based on the targeted audience. The cost may increase based on the popularity of the targeted audience or difficulty in identifying or advertising to the targeted audience. In other examples, the one or more merchants may receive a discount for certain advertising services based on participation in a program, the number of months that the one or more merchant has been a customer of the one or more advertising providers, and the like.

In further embodiments, the amount owed is based on the results of the offer advertising. For example, the amount owed may be linked to an increase or decrease in business activity such that the payments for offer advertising vary from period to period. If sales of a product associated with an offer advertisement decreased by 10% during a current period from a previous period, for example, the amount owed to the one or more advertising providers may also decrease by 10% or by a pre-selected fixed amount or ratio. In other examples, the amount owed may be a base amount and additional amounts may be tied to advertising performance. For example, the one or more merchants may require that the advertising result in redemption of a certain number of offers in order for the advertising providers to receive a performance bonus.

In some embodiments, the amount owed is based on the payment data and/or additional data. Exemplary additional data includes historical data, payment or advertising data associated with other merchants or advertising providers, and the like. For example, the amount owed may be based on payments made to the one or more advertising provider by other merchants for the same or similar services. Service or product rates for competitors of the one or more advertising providers may also be used in determining the amount owed. Rates of competitors can be used to gauge whether the amount owed to the one or more advertising providers is below, above, or at market value. If the competitors' rates and the one or more advertising providers' rates are widely different, the one or more merchants can be informed and/or prompted to take action. The one or more merchants or the system of process 300 may prompt the one or more advertising providers to give an explanation of the discrepancy, renegotiate service contracts, ask for refunds, ask for lower rates, and the like. In other examples, the amount owed may be based at least on the one or more merchant's payments over the last six months.

In still other embodiments, the amount owed is based on a formula. For example, a set amount is multiplied by a factor to determine the amount owed to a specific advertising provider. The set amount, in one example, may be $1,000 and whether the set amount is increased or decreased depends on the value of the factor by which the set amount is multiplied. In some embodiments, the factor is a set value. For example, each of the one or more advertising providers may be assigned a particular factor. In other embodiments, the factor for a particular advertising provider varies based on any number of criteria. Exemplary criteria include advertising performance, increases or decreases in the one or more merchant are business activity, inflation adjustments, increases or decreases in the advertising provider's audience, and the like. Increases associated with the criteria, in some cases, can be associated with increases in the factor from a previous value or a factor >1, while decreases associated with the criteria can be associated with decreases in the factor from a previous factor value.

As illustrated at block 314, at least a portion of the payment to at least one of the one or more advertising providers is distributed based on the determination of the amount owed. In some embodiments, the portion of the payment distributed to the one advertising providers comprises an amount greater than, less than, or equal to the determined amount. For example, a certain additional amount may be added to the determined amount to cover taxes, fixed sums, service amounts, and the like. In such cases, the total amount can be calculated by multiplying the determined amount by a certain percentage or by adding a pre-selected amount to the determined amount. In other examples, a pre-selected or calculated amount may be subtracted from the determined amount. The amount to be subtracted may be associated with refund amounts, applied discounts, applied rewards, changes in service sums or account balances, and the like. In some cases, where the distributed portion of the payment is less that the determined amount, the calculated difference of the distributed portion and the determined amount can be added to the next bill such that the total balance for the next due date is increased. In such cases, an additional sum (e.g., an interest percentage), in some embodiments, is added to the difference.

In some embodiments, the determined amount comprises the total amount owed to the one or more advertising providers. The total amount can be divided into portions. For example, the total amount can be divided into smaller amounts based on a service associated with the smaller amount, a matter associated with the smaller amount, and the like. In such cases, the one or more advertising providers can also be provided with a statement detailing the payment.

Although the illustrated embodiments presented herein describe payments for offer advertising and distribution of payments or portions thereof to advertising providers, it will be understood that the embodiments can include payments for settling offers. For example, if the one or more merchant is an offer provider or a manufacturer of a particular product associated with the offer, payment for redeemed offers (e.g., coupons applied to a purchase at a point of sales) may be distributed to retailers that accepted the offers. In alternative or additional examples, the one or more merchants include a retailer or other business that distribute offers provided by an offer provider and receive a benefit from distributing the offer such as an increase in customers or sales. In such cases, a percentage of profit, a fixed fee, or other payment may be distributed to the offer providers.

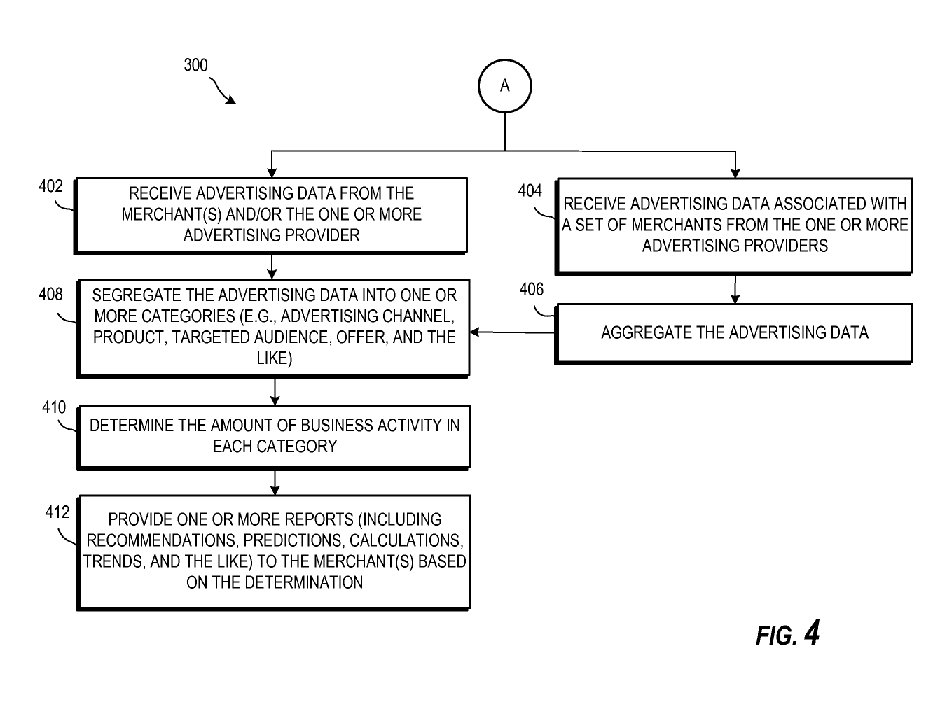

Referring now to FIG. 4, the process 300 is further illustrated. As illustrated at block 402, advertising data from the one or more merchants and/or the one or more advertising providers is received. The advertising data may be the same or different as the advertising data of the payment data. Exemplary advertising data includes targeted audience data, types of advertising channels, images, audio, or text of the advertisements, terms of the offer, product data, terms of the advertisement, contract data, historical data, and the like.

As illustrated at block 404, advertising data associated with a set of merchants is received from the one or more advertising providers. In some embodiments, the set of merchants include the merchant and/or one or more other merchants. The one or more other merchants include merchants that are similar to and/or different from the merchant. Similar merchants include merchants that sell the same or similar products as the one or more merchants, merchants that have the same or similar business model as the one or more merchants, merchants that have the same or similar type of business as the one or more merchants, and the like. In this way, advertising data for similar merchants can be used to get an “apples-to-apples” comparison, while advertising data for merchant that are different from the merchant can be used to gain a broader view of various trends.

In one example, if the one or more merchants include a restaurant, then that restaurant may be compared to other restaurants on a geographically local, national, or global level. To obtain an even closer comparison, the restaurants may be matched and compared based on the style of food that is served, price range, type of restaurant (e.g., nationwide chain, local chain, locally owned, etc.), and the like. In other examples, all merchants in a particular geographic area may be evaluated. In still other examples, businesses that are different but complementary or beneficial to the one or more merchants may also be evaluated. Merchants that are different from the one or more merchants may be beneficial to the one or more merchants based on proximity, customer demographics, products, and the like. For example, an upscale clothing store located in the same shopping center as a high end furniture store may attract customers having a certain income such that the upscale clothing store provides a benefit to the high end furniture store. The advertising campaigns and offers of such complimentary merchants can be matched to the advertising campaigns and offer of the one or more merchants for evaluation. In further examples, advertisement campaigns and offers associated with other merchants that are unrelated to the one or more merchants may be evaluated based on customer demographics. For example, if the majority of customers of a locally owned video game store are under 25 years of age, the advertising data of that video game store may be analyzed to determine how a large chain grocery store may structure their advertising to attract customers who are under 30 years old even though the stores are dissimilar.

As illustrated at block 406, the advertising data is aggregated. In some embodiments, fluctuations in business activity are measured based on the aggregated advertising data. In some embodiments, increases and decreases in business activity and the length of the increases and decreases are measured. The fluctuations, in some embodiments, are linked to certain categories of data. Business activity and categories of advertising data are discussed in more detail below.

As illustrated at block 408, the advertising data is segregated into one or more categories. For example, the advertising data may be divided into various categories such that specific aspects of the data can be highlighted and monitored. The categorization of the data, in some embodiments, is based on advertising channels, advertising content, products, offers, targeted audience demographics, periods of time, and the like. For example all advertising data associated with social media advertising may be segregated into one category, and the category may be further divided into sub-categories based on the identity of the social media provider, type of offer, and the like.

As illustrated at block 410, the amount of business activity in each category is determined. The business activity includes merchant exposure, number of redeemed offers, number of advertising views or web page views, number of clicks associated with the advertising, total number of advertising viewers, number of targeted audience members that have been exposed to the advertising, increases or decreases in sales, increases or decreases in online traffic on merchant's website, increases or decreases in foot traffic at merchant's store, number of new customers, amount and type of feedback, and the like.

In some embodiments, the targeted audience is based on customer demographics such as age, ethnicity, social status, legal status, individual or household income, geographical location, education, household size, and the like. In other embodiments, the targeted audience is based on spending activity, group memberships, publicly available social profiles, product ownership data, and the like. For example, demographic data may be combined with spending activity, group memberships, social profiles and/or product ownership data to identify the target audience. Single college students under age 27, for example, may purchase gaming equipment much more frequently than other individuals. Based on such findings, the target audience for offers for computer games and equipment may include individuals having an age range of 19 to 28 and who live within a 20 mile radius of a university.

The exposure of the merchant through the offer advertising, in some embodiments, includes exposure to non-customers or existing customers. Gauging this type of activity can indicate the value of the offer advertising. For example, an increase in merchant exposure to non-customers may result in potential new customers, while an increase in exposure to existing customers can provide incentives to these customers and increase sales. The audience the merchant seeks to target with the offer advertising can also be a beneficial indicator. The targeted audience includes, for example, non-customers, inactive customers, and existing customers.

The amount of business activity in one category can be used to determine increases or decreases in business activity associated with other categories. For example an increase in sales or offer redemptions of one product can cause a permanent or temporary increase or decrease in sales of another product. If the merchant has a partnership with a certain manufacturer of a product, has a large inventory of the product, or if the merchant can make a larger profit by selling the product over another product, the merchant may direct offer advertising to the one product to increase sales of the product and/or reduce sales of another product. In other examples, the merchant may increase sales of a particular product by decreasing or terminating offer advertising of a similar product and/or increasing offer advertising for the particular product. In still other examples, the merchant may increase overall sales or traffic to their stores or online web sites by providing attractive incentives for a popular item.

As illustrated at block 412, one or more reports are provided to the one or more merchants based on the determination of the amount of business activity. The reports include recommendations, predictions, calculations, rankings, comparisons, conclusions, potential issues and solutions, trends, and/or the like. The report includes data that is generated during a certain period such as real time data, current data, historical data, and the like. In some embodiments, the one or more reports are based on supplemental data. Exemplary supplemental data includes weather data for particular geographic regions, market segment activity, customer demographics, social media data, the payment data, and the like.

The information in the one or more reports can be packaged in any way. For example, the various elements of the one or more reports such as recommendations and calculations can be segregated into the categories discussed hereinabove. As another example, the reports can segregated into merchant specific data and/or aggregate data. In some embodiments, the report is segregated and/or formatted according to user preferences.

The recommendations include, for example, a type of offer, at type of product, a type of advertising channel, targeted audience, period of time to the run the offer advertisements, length of advertisements, frequency advertisement are provided to viewers, and the like. Based on business activity in certain demographic categories, for example, a recommendation that a merchant give discounts to individuals over age 65 may be provided so that the merchant can increase their customer base. In other examples, specific offer terms may be suggested to the merchant based on the success rates of certain types of offers. In some embodiments, the recommendations are provided in response to a potential issue, a trend, and/or the like. If an offer directed to incentivizing the customer to buy a greater quantity of items to get a discount does not result in an increase in sales, for example, a recommendation that a discount be applied to single items may be provided.

Exemplary trends include trends associated with a product, second merchant, offer, and/or advertising channel. The trends, in some embodiments, indicate the popularity of a certain type of advertising channel, product, of offer. The second merchant, in some embodiments, includes merchants that sell the same or similar types of products as the one or more merchants, or that has the same type of business as the one or more merchants.

In some embodiments, the one or more trends include trends associated with a specific locality and/or a similar business. For example, competitive businesses such as restaurants located in the same geographic location as the one or more merchants are determined to have increased advertisements for discounted meals to people who live or work in or near the geographic location via a community web site in the last six months. Based on such assessments of the competitive businesses, the one or more merchants may increase advertising, provide similar offers, or try a different advertising approach. In other embodiments, the one or more trends include trends associated with a large geographic area and a large number of different types of business. In further examples, the one or more trends may be linked to an event or a time period. For example, advertising associated with mobile book applications may reach a wider and larger audience during peak traffic times for cities that have a large population of public transportation commuters. For cities that have a large population that drive to work, radio advertisement on certain stations or billboard advertisements may reach a larger or more targeted audience.

The measured business activity, calculations, and comparisons can be used to rank certain aspects of the advertising data, make predictions, and identify issues and trends. For example, a comparison of total sales of a certain product or total sales in certain stores and types of offer can be used to indicate which offers are the most cost effective. Even though a certain type of advertising channel or provider may cost more than others, a merchant may decide that the extra cost may be worthwhile based on the report. In another example, weather data such as rain and snow averages, hurricane statistics, and/or temperature trends can be used to determine the best time to advertise, the likelihood of increasing in-store foot traffic, product transportation glitches, and the like. In one example, temporary increases in the sales of a particular product or the number of people who visit a particular store may be attributed to a particular advertising campaign. In such cases, the advertising data may be further evaluated to pin point the exact factors of the advertising campaign such as the advertising channel, the targeted audience, and/or the terms of the offer that resulted in the increased business activity. Supplemental data such as publicly available social media data, geographical data, events (e.g., seasonal, weather, or political events), or other data that may have influenced the impact of the advertising campaign may also be evaluated.

In some embodiments, the elements of the reports are based on input provided by the one or more merchants. For example, a merchant may input a desired goal (e.g., % sales increase), a target audience, a specific product, a type of offer, and advertising channel, and the like. Based on the merchant's input, various report features can be calculated. Exemplary report features include ranking of the most popular offers for a particular product, the potential obstacles to the desired goal, and the like. In this way, the report focuses on the information that is of most interest to the one or more merchants.

In some embodiments, the one or more merchants are presented with an online dashboard. For example, the one or more merchants may access the dashboard via a web page by inputting user credentials and security information. The dashboard allows the one or more merchants to monitor and analyze the one or more reports and/or categorized advertising data. For example, the one or merchants can view types of offers such as cash back and discounts and determine the number of offers redeemed for each type of offer, the period the offers were redeemed, as well as the total amounts for each of the offers.

The flowcharts and block diagrams in the Figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems which perform the specified functions or acts, or combinations of special purpose hardware and computer instructions.

The terminology used herein is for the purpose of describing particular embodiments only and is not intended to be limiting of embodiments of the disclosure. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to embodiments of the disclosure in the form disclosed. Many modifications and variations will be apparent to those of ordinary skill in the art without departing from the scope and spirit of embodiments of the disclosure. The embodiment was chosen and described in order to best explain the principles of embodiments of the disclosure and the practical application, and to enable others of ordinary skill in the art to understand embodiments of the disclosure for various embodiments with various modifications as are suited to the particular use contemplated. Although specific embodiments have been illustrated and described herein, those of ordinary skill in the art appreciate that any arrangement which is calculated to achieve the same purpose may be substituted for the specific embodiments shown and that embodiments of the disclosure have other applications in other environments. This application is intended to cover any adaptations or variations of the present disclosure. The following claims are in no way intended to limit the scope of embodiments of the disclosure to the specific embodiments described herein.

This application incorporates by reference in its entirety the following application filed concurrently herewith: U.S. application Ser. No. ______, entitled BID SYSTEM FOR ADVERTISEMENT OFFERINGS filed Jan. 1, 2013 to David M. Grig (Atty. Dkt. 5481US1.014033.1802).

What is claimed is:

1. A system for distributing payments for offer advertisements, the system comprising:
a computer apparatus including a processor and a memory; and
a distribution software module stored in the memory, comprising executable instructions that when executed by the processor cause the processor to:
receive payment data from a merchant, the payment data comprising at least one payment for advertising;
identify one or more advertising providers based on the payment data;
determine the amount owed to each of the one or more advertising providers;
distribute at least a portion of the at least one payment to at least one of the one or more advertising providers based on the determined amount.

2. The system of claim 1, wherein the payment data further comprises merchant identifiers, advertising provider identifiers, financial account information, customer account information, balances, advertising data, and offer data.

3. The system of claim 1, wherein the module is further configured to:
compare the advertising currently provided to the merchant with previous advertising;
determine a change in advertising;
increase or decrease the amount owed in accordance with the change in advertising.

4. The system of claim 3, wherein the module is further configured to:
calculate the difference of the amount owed and the at least one payment;
determine that the amount owed is less than the at least one payment; and
return the difference to the merchant.

5. The system of claim 3, wherein the module if further configured to:
calculate the difference of the amount owed and the at least one payment;
determine that the amount owed is greater than the at least one payment; and
request the difference from the merchant.

6. The system of claim 1, wherein the module is further configured to:
receive advertising data from the advertising provider, wherein the advertising data is associated with the merchant or as set of other merchants.

7. The system of claim 6, wherein the module is further configured to:
categorize the advertising data according to a type of advertising channel, a type of product, or a type of offer;
determine the amount of business activity in each category; and
provide a recommendation to the merchant based on the determination.

8. The system of claim 6, wherein the module is further configured to:
analyze the advertising data; and
determine one or more trends based on the analysis.

9. The system of claim 8, wherein the set of other merchants include merchants that have a type of business that is similar to the merchant's type of business.

10. The system of claim 8, wherein the set of other merchants include merchants that have a type of business that is different from the merchant's type of business.

11. The system of claim 1, wherein the payment data further comprises at least one payment for settling offers.

12. A computer program product for distributing payments for offer advertisements, the computer program product comprising:
a computer readable storage medium having computer readable program code embodied therewith, the computer readable program code comprising:
computer readable program code configured to receive payment data from a merchant, the payment data comprising at least one payment for advertising;
computer readable program code configured to identify one or more advertising providers based on the payment data;
computer readable program code configured to determine the amount owed to each of the one or more advertising providers; and
computer readable program code configured to distribute at least a portion of the at least one payment to at least one of the one or more advertising providers based on the determined amount.

13. The computer program product of claim 11, wherein the payment data further comprises merchant identifiers, advertising provider identifiers, financial account information, customer account information, balances, advertising data, and offer data.

14. The computer program product of claim 13, further comprising computer readable program code configured to compare the advertising currently provided to the merchant with previous advertising; determine a change in advertising; and increase or decrease the amount owed in accordance with the change in advertising.

15. The computer program product of claim 13, further comprising computer readable program code configured to receive advertising data from the advertising provider, wherein the advertising data is associated with the merchant; categorize the advertising data according to a type of advertising channel, a type of product, or a type of offer; determine the amount of business activity in each category; and provide a recommendation to the merchant based on the determination.

16. The computer program product of claim 11, further comprising computer readable program code configured to receive advertising data from the advertising provider, wherein the advertising data is associated with a set of other merchants; analyze the advertising data; and determine one or more trends based on the analysis.

17. A method for distributing payments for offer advertisements, the method comprising:
receiving, at a computing device, payment data from a merchant, the payment data comprising at least one payment for advertising;
identifying, as performed by a computing device processor, one or more advertising providers based on the payment data;
determining, as performed by a computing device processor, the amount owed to each of the one or more advertising providers; and
distributing, as performed by a computing device processor, at least a portion of the at least one payment to at least one of the one or more advertising providers based on the determined amount.

18. The method of claim 17, further comprising:
comparing, as performed by a computing device processor, the advertising currently provided to the merchant with previous advertising;
determining, as performed by a computing device processor, a change in advertising; and
increasing or decreasing, as performed by a computing device processor, the amount owed in accordance with the change in advertising.

19. The method of claim 17, further comprising:
receiving, as performed by a computing device processor, advertising data from the advertising provider, wherein the advertising data is associated with the merchant;
categorizing, as performed by a computing device processor, the advertising data according to a type of advertising channel, a type of product, or a type of offer;
determining, as performed by a computing device processor, the amount of business activity in each category; and provide a recommendation to the merchant based on the determination.

20. The method of claim 17, further comprising:
receiving, as performed by a computing device processor, advertising data from the advertising provider, wherein the advertising data is associated with a set of other merchants;
analyzing, as performed by a computing device processor, the advertising data; and
determining, as performed by a computing device processor, one or more trends based on the analysis.
